(19) United States
(12) Patent Application Publication
(10) Pub. No.: US 2011/0126113 A1
(43) Pub. Date: May 26, 2011

(54) DISPLAYING CONTENT ON MULTIPLE WEB PAGES

(75) Inventors: Asankhaya Sharma, Uttar Pradesh (IN); Prashant Kumar Dhingra, Redmond, WA (US)

(73) Assignee: c/o Microsoft Corporation, Redmond, WA (US)

(21) Appl. No.: 12/623,458

(22) Filed: Nov. 23, 2009

(51) Int. Cl. G06F 3/00

(52) U.S. Cl. 715/738

(57) ABSTRACT

Aspects of the subject matter described herein relate to displaying content on multiple pages. In aspects, a request for content is received from a browsing component. The content is divided into pages suitable for displaying on a display associated with the browsing component. Navigation elements may be embedded in the pages to allow a user using the browsing component to navigate between pages corresponding to the content. The actions of dividing the content into multiple pages may occur on a content server, an entity intermediate to the content server and a client hosting the browsing component, or a component of the client.

### BACKGROUND

Web pages that are built for a desktop display often do not display well when a smaller display is used. On the smaller display, a user may need to scroll vertically and/or horizontally to view the content of a larger Web page. This may be time consuming and frustrating for the user.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Briefly, aspects of the subject matter described herein relate to displaying content on multiple pages. In aspects, a request for content is received from a browsing component. The content is divided into pages suitable for displaying on a display associated with the browsing component. Navigation elements may be embedded in the pages to allow a user using the browsing component to navigate between pages corresponding to the content. The actions of dividing the content into multiple pages may occur on a content server, an entity intermediate to the content server and a client hosting the browsing component, or a component of the client.

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

The phrase “subject matter described herein” refers to subject matter described in the Detailed Description unless the context clearly indicates otherwise. The term “aspects” is to be read as “at least one aspect.” Identifying aspects of the subject matter described in the Detailed Description is not intended to identify key or essential features of the claimed subject matter.

The aspects described above and other aspects of the subject matter described herein are illustrated by way of example and not limited in the accompanying figures in which like reference numerals indicate similar elements and in which:

### BRIEF DESCRIPTION OF THE DRAWINGS

FIG. 1 is a block diagram representing an exemplary general-purpose computing environment into which aspects of the subject matter described herein may be incorporated;

FIG. 2 is a block diagram representing an exemplary environment in which aspects of the subject matter described herein may be implemented;

FIG. 3 is a block diagram that generally represents exemplary actions that may occur in accordance with aspects of the subject matter described herein;

FIG. 4 is a block diagram that represents an apparatus configured in accordance with aspects of the subject matter described herein; and

FIGS. 5-6 are flow diagrams that generally represent actions that may occur in accordance with aspects of the subject matter described herein.

### DETAILED DESCRIPTION

### Definitions

As used herein, the term “includes” and its variants are to be read as open-ended terms that mean “includes, but is not limited to.” The term “or” is to be read as “and/or” unless the context clearly dictates otherwise. The term “based on” is to be read as “based at least in part on.” The terms “one embodiment” and “an embodiment” are to be read as “at least one embodiment.” The term “another embodiment” is to be read as “at least one other embodiment.” Other definitions, explicit and implicit, may be included below.

### Exemplary Operating Environment

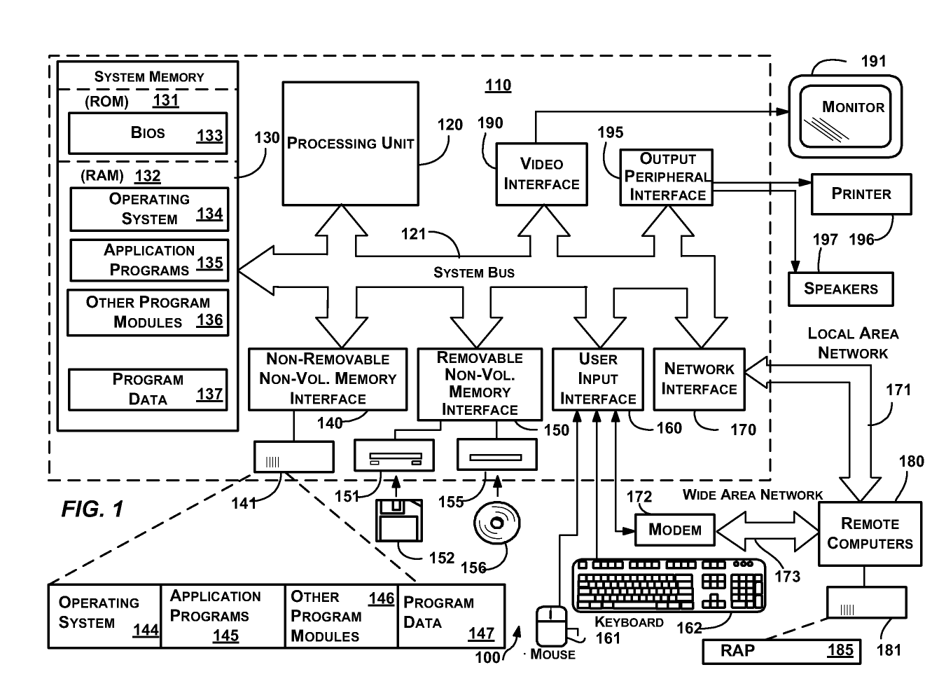

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well known computing systems, environments, or configurations that may be suitable for use with aspects of the subject matter described herein comprise personal computers, server computers, hand-held or laptop devices, multiprocessor systems, microcontroller-based systems, set-top boxes, programmable consumer electronics, network PCs, minicomputers, mainframe computers, personal digital assistants (PDAs), gaming devices, printers, appliances including set-top, media center, or other appliances, automobile-embedded or attached computing devices, other mobile devices, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. A computer may include any electronic device that is capable of executing an instruction. Components of the computer 110 may include a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, Peripheral Component Interconnect Extended (PCI-X) bus, Advanced Graphics Port (AGP), and PCI express (PCIe).

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media.

Computer storage media includes both volatile and nonvolatile, removable and non-removable media implemented in any method or technology for storage of information such as computer-readable instructions, data structures, program modules, or other data. Computer storage media includes RAM, ROM, EEPROM, flash memory or other memory technology, CD-ROM, digital versatile discs (DVDs) or other optical disk storage, magnetic cassettes, magnetic tape, magnetic disk storage or other magnetic storage devices, or any other medium which can be used to store the desired information and which can be accessed by the computer 110.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM or other optical media. Other removable/non-removable, volatile/nonvolatile computer storage media that can be used in the exemplary operating environment include magnetic tape cassettes, flash memory cards, digital versatile discs, other optical discs, digital video tape, solid state RAM, solid state ROM, and the like. The hard disk drive 141 is typically connected to the system bus 121 through a non-removable memory interface such as interface 140, and magnetic disk drive 151 and optical disc drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies.

A user may enter commands and information into the computer 110 through input devices such as a keyboard 162 and pointing device 161, commonly referred to as a mouse, trackball, or touch pad. Other input devices (not shown) may include a microphone, joystick, game pad, satellite dish, scanner, a touch-sensitive screen, a writing tablet, or the like. These and other input devices are often connected to the processing unit 120 through a user input interface 160 that is coupled to the system bus, but may be connected by other interface and bus structures, such as a parallel port, game port or a universal serial bus (USB).

A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets, and the Internet.

When used in a LAN networking environment, the computer 110 is connected to the LAN 171 through a network interface or adapter 170. When used in a WAN networking environment, the computer 110 may include a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Multiple Web Pages

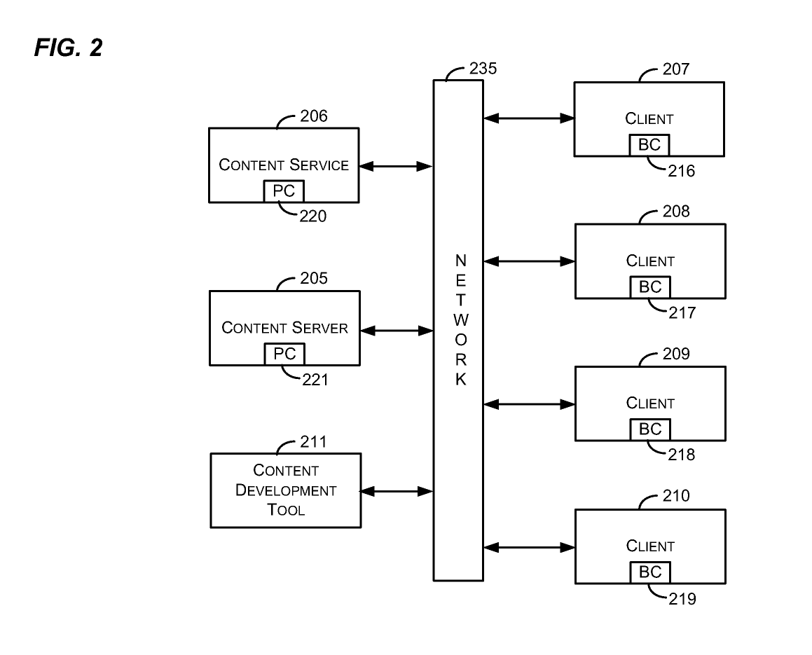

As mentioned previously, web pages that are built for a desktop display often do not display well when a smaller display is used. FIG. 2 is a block diagram representing an exemplary environment in which aspects of the subject matter described herein may be implemented. The environment may include a content server 205, a content service 206, clients 207-210, a content development tool 211, and may include other entities (not shown). The various entities may be located relatively close to each other or may be distributed across the world. The various entities may communicate with each other via various networks including intra- and inter-office networks and the network 235. The clients 207-210 may include browsing components 216-219, which are described in more detail below.

In an embodiment, the network 235 may comprise the Internet. In an embodiment, the network 235 may comprise one or more local area networks, wide area networks, direct connections, virtual connections, private networks, virtual private networks, some combination of the above, and the like.

The content server 205, the content service 206, the clients 207-210, and the web page development tool 211 may comprise or reside on one or more computing devices. Such devices may include, for example, personal computers, server computers, hand-held or laptop devices, multiprocessor systems, microcontroller-based systems, set-top boxes, programmable consumer electronics, network PCs, minicomputers, mainframe computers, cell phones, personal digital assistants (PDAs), gaming devices, printers, appliances including set-top, media center, or other appliances, automobile-embedded or attached computing devices, other mobile devices, distributed computing environments that include any of the above systems or devices, and the like. An exemplary device that may be configured to act as one of the above comprises the computer 110 of FIG. 1.

Although the terms “client” and “server” are sometimes used herein, it is to be understood, that a client may be implemented on a machine that has hardware and/or software that is typically associated with a server and that likewise, a server may be implemented on a machine that has hardware and/or software that is typically associated with a desktop, personal, or mobile computer. Furthermore, a client may at times act as a server and vice versa. At times, two or more entities that more frequently act as a client or server may concurrently be peers, servers, or clients. In an embodiment, a client and server may be implemented on the same physical machine.

Furthermore, as used herein, each of the terms “server” and “client” may refer to one or more physical or virtual entities, one or more processes executing on one or more physical or virtual entities, and the like. Thus, a server may include an actual physical node upon which one or more processes execute, a virtual node upon which one or more processes execute, a service executing on one or more nodes, a group of nodes that together provide a service, and the like. A service may include one or more processes executing on one or more physical or virtual entities. Furthermore, a single process may implement one or more servers.

The term “process” and its variants as used herein may include one or more traditional processes, threads, components, libraries, objects that perform tasks, and the like. A process may be implemented in hardware, software, or a combination of hardware and software. In an embodiment, a process is any mechanism, however called, capable of or used in performing an action. A process may be distributed over multiple devices or located on a single device.

The content server 205 may include one or more programs that provide Web pages and associated content to entities that request the Web pages. A Web page may include text, graphics, objects, links to other content, and the like.

The content service 206 may include pagination components 220 that interact with the content server 205 to provide Web pages to the clients 207-210. The pagination components may be implemented using one or more processes. In one embodiment, the pagination components 220 may implement an application programming interface (API) that allows the clients 207-210 to call the content service 206 to request content. In calling the content service 206, a client may indicate a URL and the client's display characteristics. The pagination components 220 may obtain the content indicated by the URL, identify data that is to be displayed on different pages on the client's display, divide the content into the pages, and provide the pages to the client.

In one embodiment, to assist in dividing the content into pages, the pagination components 220 may render the content into a single page on a virtual or physical display, capture a screen shot of the page, and identify the multiple pages by identifying elements in the screen shot. In another embodiment, the pagination components 220 may identify elements in the content without capturing a screen shot of the page. This may be done, for example, by parsing the HTML or other code of the page and finding the elements therein. In addition, the pagination components 220 may create a navigation page and/or navigation elements that allow a user to browse the different pages. For example, the pagination components 220 may create browser tabs that allow a user to browse the different pages.

As user herein, a virtual display may include a driver that can be used to render images to memory without displaying the images on a physical display. A virtual display may have configurable display characteristics including width and height.

The pagination components 220 may cache content from the content server 205. After the pagination components 220 have divided the content into pages, the pagination components may provide one of the pages (or a navigation page) to the requesting client. When the client navigates to another one of the pages, the pagination components 220 may access the cached content to obtain the other page and provide that to the client. When the client requests different content (e.g., from another content server), the pagination components 220 may repeat the process above with the new content.

In this embodiment, the client may include no “intelligence” regarding dividing content into multiple pages. Instead, the client may simply call the content service 206 and request content. The pagination components 220 of the content service 206 may seamlessly provide the content to the client via multiple pages that are linked together.

In another embodiment, pages may be annotated with page break markers. In this embodiment, the client may have a component that recognizes these page break markers and displays pages and navigation elements between pages accordingly as described in more detail below.

In yet other embodiments, a client may include pagination components (not shown) that perform the functions of the content service 206 and the pagination components 220. In such embodiments, the content service 206 may be omitted and a client may browse to the content server 205 via the client's pagination components without going through the content service 206. In these embodiments, the pagination components on the client may be responsible for obtaining content from the content server 205, dividing the content into Web pages, providing navigation elements, if any, between Web pages, and displaying the Web pages on a display of the client.

In one embodiment, the content server 205 may include pagination components 221 that perform the functions of the content service 206 and the pagination components 220. In such embodiments, the content service 206 may be omitted and a client may browse directly to the content server 205 without going through the content service 206.

The clients 207-210 may include browsing components 216-219, respectively. A browsing component may comprise a Web browser that is capable of requesting content from the content service 206 and rendering the content for display on a client.

The clients 207-210 may have varying display capabilities. For example, a client may have a desktop display, a laptop display, a PDA display, a cell phone display, or some other sized display.

In one embodiment, to accommodate different sized displays, a Web page may be annotated to include tags or other “markers” that indicate page breaks for various sized displays. For example, a Web page may include markers that indicate page breaks for a browser of a cell phone. In conjunction with rending Web content, the cell phone browser may scan for page breaks in the content. If the Web content includes page breaks, the cell phone browser may display content corresponding to one of the Web pages with an indication that other Web pages are also available.

A client may be configured to recognize page break markers that apply to its display while ignoring page break markers that apply to other displays. For example, when a cell phone comes across a page break marker that does not apply to the cell phone display, the cell phone may ignore the page break marker.

With the diversity of clients and their varying display capabilities, the markers may indicate page breaks for displays having certain characteristics rather than being tied to a certain type of device (e.g., laptop, cell phone, etc.). For example, markers may indicate page breaks for “small,” “medium,” and “large” displays. How to classify a particular display may be determined by one or more characteristics of the display including width, height, number of pixels, spacing of pixels, whether device can display color or not, whether the display is touch sensitive, other characteristics about the display, a combination of two or more of the above, and the like.

The naming and number of different sizes indicated above is exemplary only. In other examples, the number of sizes may be more or less than the number given above. Furthermore, their associated names, if any, may also be varied from that described above.

The content development tool 211 may allow a user, Web page developer, or the like (hereinafter developer) to develop Web pages. The content development tool 211 may allow the developer to indicate page breaks for different types of devices. These page breaks may be embedded as page break marks within the Web pages as described previously.

Although the environment described above includes various numbers of the entities and related infrastructure, it will be recognized that more, fewer, or a different combination of these entities and others may be employed without departing from the spirit or scope of aspects of the subject matter described herein. Furthermore, the entities and communication networks included in the environment may be configured in a variety of ways as will be understood by those skilled in the art without departing from the spirit or scope of aspects of the subject matter described herein.

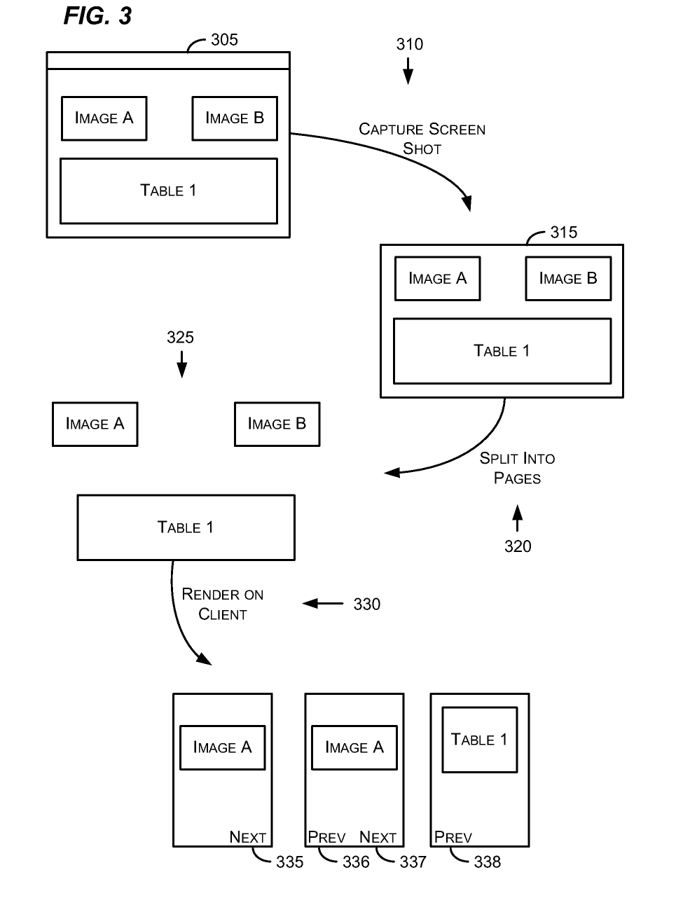

FIG. 3 is a block diagram that generally represents exemplary actions that may occur in accordance with aspects of the subject matter described herein. At 310, a screen shot of a Web page 305 is captured to create a captured screen shot 315. At block 320, the captured screen shot 315 is divided into parts 325 that may then be rendered on separate pages on a client at 330. The client may include navigation elements 335-338 that allow a user to navigate between Web pages used to display content.

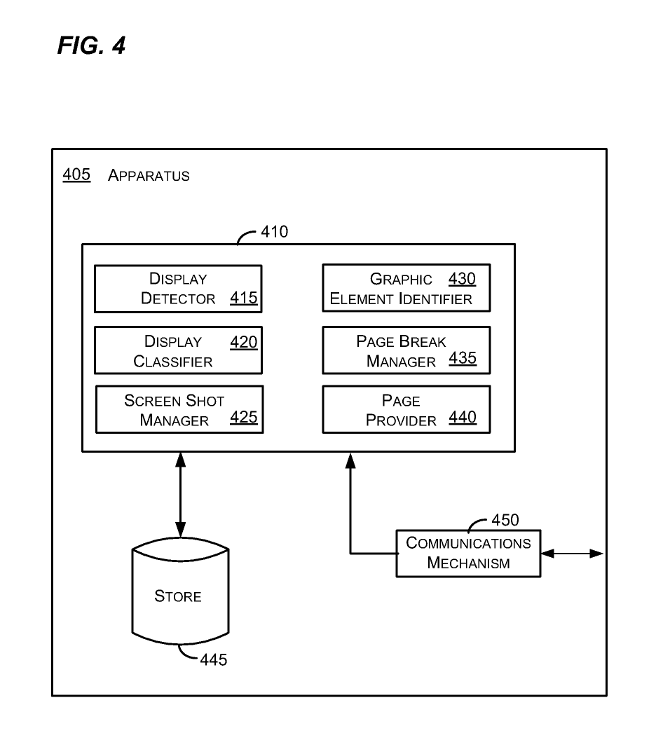

FIG. 4 is a block diagram that represents an apparatus configured in accordance with aspects of the subject matter described herein. The components illustrated in FIG. 4 are exemplary and are not meant to be all-inclusive of components that may be needed or included. In other embodiments, the components and/or functions described in conjunction with FIG. 4 may be included in other components (shown or not shown) or placed in subcomponents without departing from the spirit or scope of aspects of the subject matter described herein. In some embodiments, the components and/or functions described in conjunction with FIG. 4 may be distributed across multiple devices.

Turning to FIG. 4, the apparatus 405 may include pagination components 410, a store 445, a communications mechanism 450, and other components (not shown). The apparatus 405 corresponds to any of the content server 205, the content service 206, or the clients 207-210 of FIG. 2 and may be implemented on or as the same or similar device(s) upon which one of those entities may be implemented. For example, the apparatus 405 may be implemented on or as a computer (e.g., as the computer 110 of FIG. 1).

The pagination components 410 correspond to the pagination components that may be found on various of the entities of FIG. 2. The pagination components 410 may include a display detector 415, a display classifier 420, a screen shot manager 425, a graphic element identifier 430, a page break manager 435, a page provider 440, and other components (not shown).

The communications mechanism 450 allows the apparatus 405 to communicate with other entities. For example, the communications mechanism 450 allows the apparatus to communicate with other entities reachable via the network 235 of FIG. 2. The communications mechanism 450 may be a network interface or adapter 170, modem 172, or any other mechanism for establishing communications as described in conjunction with FIG. 1.

The store 445 is any storage media capable of provide access to content and associated data (e.g., pagination information). The store 445 may be used to store rendering data from a virtual driver in preparation for capturing a screen shot. The store 445 may comprise a file system, database, volatile memory such as RAM, other storage, some combination of the above, and the like and may be distributed across multiple devices. The store 445 may be external, internal, or include components that are both internal and external to the apparatus 405.

The display detector 415 may be operable to obtain the characteristics of the display. As mentioned previously, the characteristics may include one or more of width, height, number of pixels, spacing of pixels, color capabilities, touch sensitivity capabilities, and the like.

The display classifier 420 may be operable to determine a type of display of a client hosting the browser component. The type may indicate characteristics (e.g., small, medium, large, other characteristics, and the like) of the display.

The screen shot manager 425 may be operable to capture a screen shot of the content. The screen shot may be rendered on a virtual or physical display.

The graphic element identifier 430 is operable to locate graphic elements in the content. The graphic element identifier 430 may utilize a screen shot provided by the screen shot manager 425 or may locate graphic elements directly from the content. Machine vision or other techniques may be used to identify the graphic elements. In cases where the graphic element identifier 430 is able to locate graphic elements directly from the content, the screen shot manager 425 may be omitted.

Graphic elements may include bar charts, line charts, other charts, tables, graphs, images, or any other elements that may be represented via one or more pixels. Graphic elements may be resized (e.g., made larger or smaller), but may not be capable of being re-paragraphed or re-formatted to flow around other items in the way text can.

The page break manager 435 may be operable to determine page breaks for dividing content into multiple pages for rendering on a display. The page break manager 435 may determine the page breaks using the type of display and the graphic elements previously identified in the content.

The page provider 440 may be operable to send one or more pages to a rendering component of a client. The page provider 440 may embed links in a page that refer to other pages into which content has been divided. When a client requests content associated with one of these links, the page provider 440 may obtain another one of the pages, embed a link therein, and provide the page to the client.

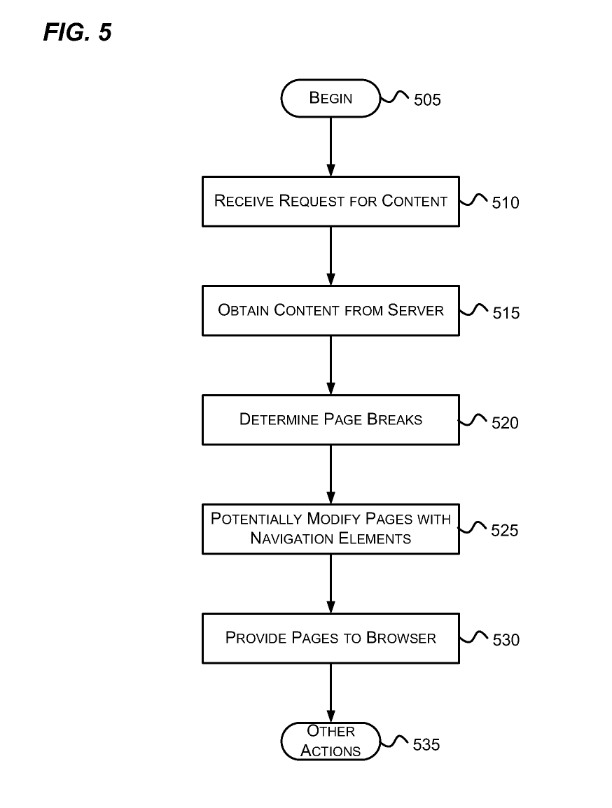

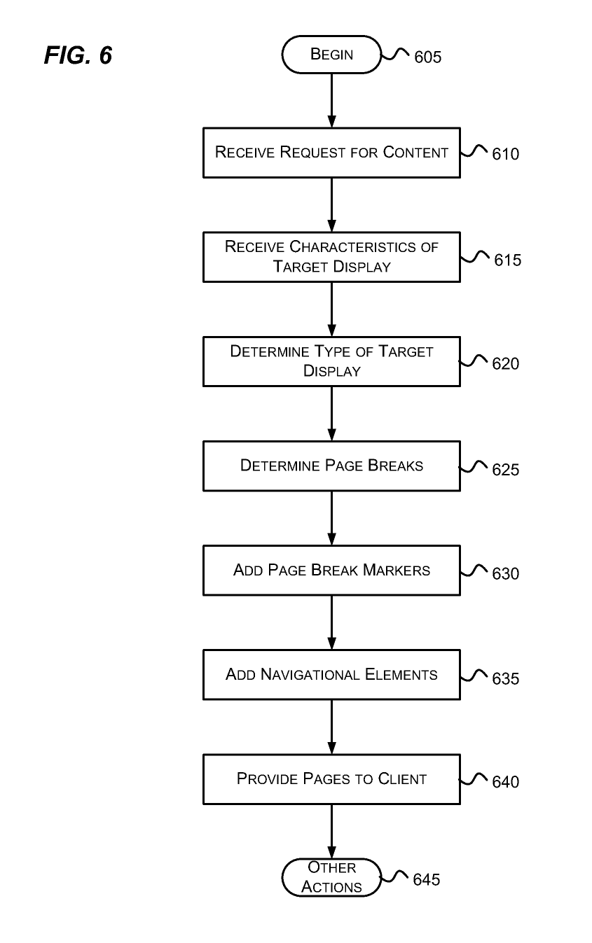

FIGS. 5-6 are flow diagrams that generally represent actions that may occur in accordance with aspects of the subject matter described herein. For simplicity of explanation, the methodology described in conjunction with FIGS. 5-6 is depicted and described as a series of acts. It is to be understood and appreciated that aspects of the subject matter described herein are not limited by the acts illustrated and/or by the order of acts. In one embodiment, the acts occur in an order as described below. In other embodiments, however, the acts may occur in parallel, in another order, and/or with other acts not presented and described herein. Furthermore, not all illustrated acts may be required to implement the methodology in accordance with aspects of the subject matter described herein. In addition, those skilled in the art will understand and appreciate that the methodology could alternatively be represented as a series of interrelated states via a state diagram or as events.

Turning to FIG. 5, at block 505, the actions begin. For example, referring to FIG. 2, the client 207 may seek to obtain content from the content server 205.

At block 510, a request for content is received. The request may come from a browser component of a client. The request may be received at the content server or at a component that is “logically” between the content server and the browser component. The term logically in this context indicates a component that receives the request before the request (or a request derived from the request) is sent to the content server. For example, referring to FIG. 2, a request from the browsing component 216 of the client 207 may be received by the content service 206 or a pagination component (not shown) that resides on the client 207.

At block 515, the content is obtained from the server. For example, referring to FIG. 2, the pagination component 220 of the content service 206, the pagination component 221 of the content server 205, or a pagination component of the client 207 may obtain content corresponding to a Web page from the content server 205.

At block 520, page breaks are determined for dividing the content into multiple pages for display on a target display (e.g., a display of a client). For example, referring to FIG. 2, the content service 206 may obtain content from the content server 205 and may determine page breaks that divide the content into multiple pages based on display characteristics of a display associated with the browser component 216. As another example, a pagination component of a client that hosts the browser may receive the request, obtain content from the content server 205, and determine the page breaks from the content. As yet another example, referring to FIG. 3, pagination components may divide the graphic elements in the screen shot 315 into parts 325 where each part is to be displayed on a separate page of display of a client.

In determining page breaks, different mechanisms may be used. For example, in one mechanisms, determining page breaks may include:

1. Rendering the content to a virtual display;

2. Capturing a screen shot of the virtual display;

3. Identifying graphic elements of the screen shot; and

4. Dividing the content into multiple pages based on the graphic elements and one or more characteristics of the target display.

As another example, determining page breaks that divide the content into multiple pages may include:

1. Parsing code included in the content;

2. Identifying graphic elements represented by the code; and

3. Dividing the content into multiple pages based on the graphic elements and one or more characteristics of the target display.

As yet another example, determining page breaks that divide the content into multiple pages may include parsing the content to locate page break markers that are applicable to the target display and ignoring other page break markers that are inapplicable to the target display.

The examples of determining page breaks above are not intended to be all-inclusive or exhaustive. Indeed, based on the teachings herein, those skilled in the art may recognize other methods for determining page breaks that may be used without departing from aspects of the subject matter described herein.

At block 525, one or more navigation elements may be added to the pages before providing the pages to the browser component. As indicated previously, a navigation element may indicate another page of the content that is reachable from a currently displayed page. For example, referring to FIG. 3, the navigation elements 335-338 may be added to pages. Adding navigation elements may include adding one or more of a tab element, hyperlink element, number elements, other graphical elements, and the like.

At block 530, the pages are provided to the browser component. This may be done page at a time as requested by the browser component or in the case of pages that include page break markers, all pages corresponding to the requested content may be provided to the browser component. For example, referring to FIG. 2, the pagination components 220 of the content service 206 may provide one page at a time, as requested, to the client 207.

At block 535, other actions, if any, may be performed.

Turning to FIG. 6, at block 605, the actions begin. For example, referring to FIG. 2, the client 207 may seek to obtain content from the content server 205.

At block 610, a request for content is received. For example, referring to FIG. 2, the content server 205 may receive a request for content from the client 207.

At block 615, one or more characteristics of a target display are received. For example, referring to FIG. 2, the content server 205 may receive the display characteristics of a display of the client 207.

At block 620, the type of the target display is determined based on the one or more characteristics. For example, referring to FIG. 410, the display classifier 420 may determine the type of the display based on the characteristics. Determining a type of the target display may include determining a discrete classification (e.g., small, medium, large, some other classification, or the like) of the target display. The term “discrete” in the context means a classification that groups similar display characteristics in buckets instead of assigning continuous (e.g., real or some other infinitely variably value) to the type.

In one embodiment, instead of sending the display characteristics, the client may simply send the type. In this example, the actions associated with blocks 615 and 620 may be omitted.

At block 625, based on the type of display, page breaks are determined for dividing the content into multiple pages for display on the target display. For example, referring to FIG. 4, the screen shot manager 425, the graphic element identifier 430, and the page break manager 435 may be involved in steps to identify page breaks as has been described previously.

At block 630, in one embodiment, page break markers may be added so that the client browser may know how to divide the content into pages. For example, referring to FIG. 4, the page break manager 435 may add page break markers to pages to provide to a requesting client. The page break markers may have been added previous to the client requesting the content and other page break markers for other types of displays may also be added to content.

At block 635, navigation elements may be added. For example, referring to FIG. 4, the page provider 440 may embed links or other navigation elements in pages provided to a requesting client.

At block 640, the pages are provided to the client. For example, referring to FIG. 4, the page provider 440 may send pages (e.g., one or many at a time) to a client.

At block 645, other actions, if any, may be performed.

As can be seen from the foregoing detailed description, aspects have been described related to displaying content on multiple pages. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A method implemented at least in part by a computer, the method comprising:
receiving, from a browser component, a request for content;
obtaining the content from a content server;
determining page breaks for dividing the content into multiple pages for display on a target display; and
providing at least one of the pages to the browser component.

2. The method of claim 1, wherein receiving a request for content comprises receiving the request at an entity that is logically between the content server and the browser component.

3. The method of claim 2, wherein receiving the request at an entity that is logically between the content server and the browser component comprises receiving the request at a content service and wherein determining page breaks that divide the content into multiple pages comprises the content service determining the page breaks based on display characteristics of a display associated with the browser component.

4. The method of claim 2, wherein receiving the request at an entity that is between the content server and the browser component comprises receiving the request at a pagination component of a client that hosts the browser and wherein determining page breaks that divide the content into multiple pages comprises the pagination component determining the page breaks from the content received from the content server.

5. The method of claim 1, wherein determining page breaks that divide the content into multiple pages comprises:
rendering the content to a virtual display;
capturing a screen shot of the virtual display;
identifying graphic elements of the screen shot; and
dividing the content into multiple pages based on the graphic elements and one or more characteristics of the target display.

6. The method of claim 1, wherein determining page breaks that divide the content into multiple pages comprises:
parsing code included in the content;
identifying graphic elements represented by the code; and
dividing the content into multiple pages based on the graphic elements and one or more characteristics of the target display.

7. The method of claim 1, wherein determining page breaks that divide the content into multiple pages comprises parsing the content to locate page break markers that are applicable to the target display and ignoring other page break markers that are inapplicable to the target display.

8. The method of claim 1, further comprising adding a navigation element to the at least one of the pages before providing the at least one of the pages to the browser component, the navigation element indicating at least another one of the pages reachable from the at least one of the pages.

9. The method of claim 8, wherein adding a navigation element to the at least one of the pages comprises adding one or more of a tab element, hyperlink element, and number element.

10. A computer storage medium having computer-executable instructions, which when executed perform actions, comprising:
receiving a request for content, the request associated with a client having a target display;
receiving an indication of one or more characteristics of the target display;
determining a type of the target display based on the one or more characteristics;
based on the type, determining page breaks for dividing the content into multiple pages for display on the target display; and
providing at least one of the pages to the client.

11. The computer storage medium of claim 10, wherein receiving an indication of one or more characteristics of the target display comprises receiving data including one or more of width, height, number of pixels, spacing of pixels, color capabilities, and touch sensitivity capabilities of the target display.

12. The computer storage medium of claim 10, wherein determining a type of the target display based on the one or more characteristics comprises determining a discrete classification of the target display, each discrete classification indicating displays having similar characteristics.

13. The computer storage medium of claim 10, wherein determining page breaks comprises:
rendering the content to a virtual display;
capturing a screen shot of the virtual display;
identifying graphic elements of the screen shot; and
dividing the content into multiple pages based on the type and the graphic elements.

14. The computer storage medium of claim 10, wherein determining page breaks comprises:
parsing code included in the content;
identifying graphic elements represented by the code; and
dividing the content into multiple pages based on the type and the graphic elements.

15. The computer storage medium of claim 10, further comprising placing page break markers into code corresponding to the pages, the page break markers corresponding to the page breaks.

16. The computer storage medium of claim 15, further comprising placing additional page break markers into code corresponding to the pages, the additional page break markers indicating page breaks for one or more other types of displays.

17. The computer storage medium of claim 10, further comprising adding a navigation element to the at least one of the pages, the navigation element indicating at least another one of the pages reachable from the at least one of the pages.

18. The computer storage medium of claim 17, wherein adding a navigation element to the at least one of the pages comprises adding one or more of a tab element, hyperlink element, and number element.

19. In a computing environment, an apparatus, comprising:
a communications component operable to receive, from a browser component, a request for content corresponding to a Web page;
a display classifier operable to determine a type of display of a client hosting the browser component, the type indicating characteristics of the display;
a graphic element identifier operable to locate graphic elements in the content; and
a page break manager operable to determine page breaks for dividing the content into multiple pages for rendering on the display, the page break manager determining the page breaks using the type of display and the graphic elements in the content.

20. The apparatus of claim 19, further comprising a screen shot manager operable to capture a screen shot of the content as rendered on a virtual display, the graphic element identifier being operable to locate graphic elements in the content via the screen shot.
